(19) United States
(12) Patent Application Publication
(10) Pub. No.: US 2026/0356226 A1
(43) Pub. Date: Nov. 12, 2026

(54) UNIVERSAL CHARGER BASE

(71) Applicant: Stephen Gerhardt, Morgan Hill, CA (US)

(72) Inventor: Stephen Gerhardt, Morgan Hill, CA (US)

(21) Appl. No.: 19/200,056

(22) Filed: May 6, 2025

(51) Int. Cl. B60L 53/31; B60L 53/18

(52) U.S. Cl. CPC B60L 53/31; B60L 53/18

(57) ABSTRACT

In an embodiment, a universal charging platform, can include a mobile support structure configured to carry and stabilize an electric vehicle charging system, a group of support brackets coupled to the mobile support structure, the support brackets configured to assist with one or more of transport, installation, or anchoring of the platform, a set of lift-access channels formed or affixed along a lateral portion of the mobile support structure and dimensioned to receive lifting implements, including forklift tines, for repositioning or transport of the platform, and a mounting interface provided atop the mobile support structure and which can removably or permanently secure the electric vehicle charging system thereon.

### TECHNICAL FIELD

Embodiments are related to mobile support systems for electric vehicle (EV) charging equipment. Embodiments also relate to the field of temporary and relocatable EV charging infrastructure. Embodiments further relate to structures and hardware for mounting, transporting, and stabilizing high-power EV chargers in diverse operating environments.

### BACKGROUND

The adoption of electric vehicles (EVs) continues to accelerate across both consumer and commercial sectors. This shift has created a growing demand for accessible and scalable EV charging infrastructure capable of supporting both short-term and long-term deployment needs. While many EV chargers are designed for permanent installation, such installations often require extensive site preparation, underground wiring, and permitting processes, which can delay deployment and limit flexibility.

Fleet operators, construction companies, event organizers, and emergency response teams often encounter scenarios where temporary but high-powered EV charging is essential. For example, businesses may need to provide charging capabilities at temporary job sites, remote locations, or leased properties where permanent infrastructure is either unavailable or unjustifiable. In the aftermath of natural disasters or power outages, rapid deployment of mobile charging capabilities can become critical to maintaining essential transportation services.

Despite these real-world needs, there is a lack of versatile, heavy-duty charging base systems that can be quickly deployed, relocated, and configured for a variety of high-power EV chargers. Existing portable solutions are often underpowered, not rugged enough for industrial or outdoor environments, or lack the safety features necessary for operation in busy or unpredictable settings such as fleet depots, parking lots, or disaster relief zones.

Furthermore, space constraints in urban and industrial environments increase the importance of compact, transportable designs that can be easily handled by standard equipment such as forklifts, while still offering stability, impact protection, and electrical versatility. The absence of an effective system to meet these demands represents a significant barrier to widespread and flexible deployment of Level 3 charging capabilities.

Accordingly, there exists a need for a mobile and rugged apparatus capable of supporting high-power EV chargers in temporary or evolving environments, while also addressing safety, convenience, and adaptability requirements for a wide range of operational scenarios.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the embodiments to provide for a mobile support system for electric vehicle (EV) charging equipment.

It is another aspect of the embodiments to provide for improved temporary and relocatable EV charging infrastructure.

It is a further aspect of the embodiments to structures and hardware for mounting, transporting, and stabilizing high-power EV chargers in diverse operating environments.

It also an aspect of the embodiments to provide for an apparatus for supporting a charging device such as an electric vehicle (EV) charger.

The aforementioned aspects and other objectives and advantages can now be achieved as described herein.

In an embodiment, an apparatus for supporting a charging device, can include: a mobile base structure configured to support a charging device, a plurality of bollards positioned about the mobile base structure, a plurality of outriggers extendable from the mobile base structure to enhance stability with respect to the mobile base structure, a plurality of brackets configured for mounting or transporting the mobile base structure, and a set of fork tubes positioned on a side of the mobile base structure and configured to receive forklift tines for lifting and relocation of the mobile base structure, wherein the mobile base structure includes a mounting plate configured to receive the charging device.

In an embodiment, the charging device can comprise an electric vehicle (EV) charger.

In an embodiment, the charging device can include a power supply associated with the EV charger.

In an embodiment, the mounting plate can be configured to receive the charging device having a base footprint of less than three feet by three feet and requiring up to 800 amps of 480-volt three-phase power.

In an embodiment, the plurality of bollards can be removably attachable to respective tops of the plurality of outriggers to reduce tripping hazards and provide impact protection

In an embodiment, onboard storage can be integrated into the mobile base structure for storing accessories including one or more of the following: the plurality of bollards, the outriggers, and a set of DLO power cables.

In an embodiment, the convenience receptacle(s) can be mounted on the mobile base structure and configured to supply power to auxiliary equipment, including lighting systems.

In an embodiment, a universal charging platform, can include: a mobile support structure configured to carry and stabilize an electric vehicle charging system; a plurality of support brackets coupled to the mobile support structure, the support brackets configured to assist with one or more of transport, installation, or anchoring of the platform; a set of lift-access channels formed or affixed along a lateral portion of the mobile support structure and dimensioned to receive lifting implements, including forklift tines, for repositioning or transport of the platform; and a mounting interface provided atop the mobile support structure and configured to removably or permanently secure the electric vehicle charging system thereon.

In an embodiment, a plurality of protective posts can be disposed around at least a portion of the mobile support structure and configured to mitigate external impact.

In an embodiment, a plurality of stabilizing members can extend outwardly from the mobile support structure to increase a footprint of the platform and provide enhanced stability during operation.

In an embodiment, one or more convenience receptacles can be mounted on the mobile support structure and configured to supply power to auxiliary equipment.

In an embodiment, the convenience receptacles may include one or more of an electrical enclosure and a transformer.

In an embodiment, a method of deploying a charging support platform, can involve: providing a mobile base structure configured to support a charging device; positioning a plurality of bollards about the mobile base structure to protect the charging device from impact; extending a plurality of outriggers from the mobile base structure to enhance the stability of the platform; utilizing a plurality of brackets to facilitate mounting, transport, or anchoring of the mobile base structure; and lifting or relocating the mobile base structure by inserting forklift tines into a set of fork tubes positioned along a side of the mobile base structure, wherein the mobile base structure includes a mounting plate configured to receive the charging device.

An embodiment of the method can involve supporting an electric vehicle (EV) charging device with the mobile base structure.

An embodiment of the method can involve integrating a power supply with the EV charging device mounted on the mobile base structure.

An embodiment of the method can further involve installing a charging device onto the mounting plate, wherein the charging device has a base footprint of less than three feet by three feet and requires up to, for example, 800 amps of 480-volt three-phase power.

An embodiment of the method can involve attaching the plurality of bollards to tops of the outriggers to provide impact protection while reducing tripping hazards around the deployed structure.

An embodiment of the method can involve storing one or more of the bollards, outriggers, or power cables in onboard storage compartments integrated into the mobile base structure.

An embodiment of the method can involve supplying power to auxiliary equipment via one or more convenience receptacles mounted on the mobile base structure.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention.

FIG. 1 illustrates a perspective view of an apparatus for supporting a charging device including a mobile base structure, a group of bollards and other components, in accordance with an embodiment;

FIG. 2 illustrates a perspective of the apparatus shown in FIG. 1 including the mobile base structure without the bollards and other components, in accordance with an embodiments;

FIG. 3 illustrates an internal view of the mobile base structure shown in FIG. 1 and FIG. 2;

FIG. 4 illustrates a top perspective view including the internal components of the mobile base structure, in accordance with an embodiment;

FIG. 5 illustrates a side perspective view of the apparatus for supporting a charging device, in accordance with an embodiment;

FIG. 6 illustrates a perspective view opposite the view shown in FIG. 5 of the apparatus for supporting a charging device, in accordance with an embodiment;

FIG. 7 illustrates a top perspective view of the apparatus, in accordance with an embodiment; and

FIG. 8 illustrates a perspective and internal view of the apparatus, in accordance with an embodiment;

FIG. 9A and FIG. 9B illustrate varying perspective views of the apparatus with bollards in different positions along with the charging device supported and stabilized by the mobile base structure, in accordance with an embodiment;

FIG. 9C illustrates different views of the electrical enclosure, in accordance with varying embodiments;

FIG. 10 illustrates an exploded view of the apparatus, in accordance with an embodiment;

FIG. 11A and FIG. 11B illustrate an exploded view of an example leg of an outrigger, in accordance with an embodiment;

FIG. 12 illustrates a pictorial view of an example side outrigger, which can be implemented in accordance with an embodiment;

FIG. 13 illustrates a pictorial view of an example front outrigger, which can be implemented in accordance with an embodiment;

FIG. 14 illustrates a pictorial diagram of a breaker box, which can be implemented in accordance with an embodiment;

FIG. 15 illustrates a flow chart of operations depicting logical operational steps of a method for deploying a charging support platform, in accordance with an embodiment;

FIG. 16 illustrates a perspective view of the internal components of an apparatus for supporting a charging device including a mobile base structure, in accordance with an embodiment;

FIG. 17 illustrates a perspective view of interior framing for the mobile base structure, in accordance with an embodiment.

Like reference numerals utilized herein can refer to identical or similar parts or elements.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context. Furthermore, the term “at least one” as utilized herein can refer to “one or more”. For example, “at least one widget” may refer to “one or more widgets.”

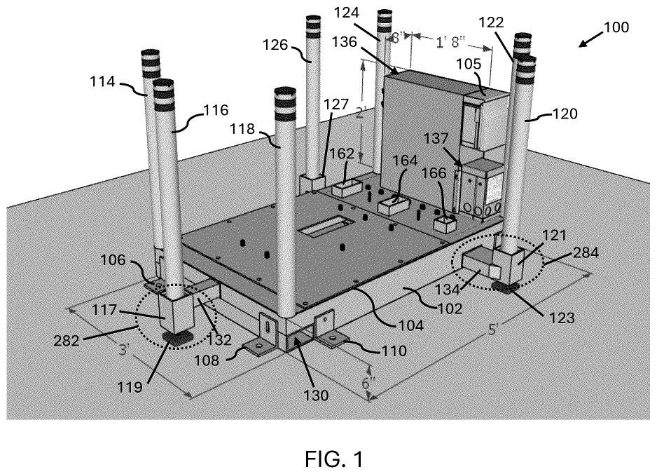

FIG. 1 illustrates a perspective view of an apparatus 100 for supporting a charging device (not shown in FIG. 1) including a mobile base structure 102, a group of bollards 114, 116, 118, 120, 122, 124, 126 along with other components, which are described in greater detail below, in accordance with an embodiment. The apparatus 100 can be configured to support and stabilize, for example, a high-power electric vehicle (EV) charging device (e.g., a Level 3 DC fast charger), particularly in temporary or relocatable environments. It should be appreciated that the embodiments are not limited to supporting and stabilizing high-power electric vehicle (EV) charging devices but can be adapted for use in supporting a variety of other charging devices, along with supporting and stabilizing other types of devices.

The apparatus 100 is especially suited for use in settings such as commercial fleet operations, construction zones, leased or remote properties, and emergency response scenarios. Note that term “mobile base structure” herein can be utilized interchangeably with the term “base” to refer to the same component. The mobile base structure 102 can function as a Universal Charging Base (UCB). Example models can include a UCB-400 (e.g., UCB capable of up to 400-amps) and a UCB-800 (e.g., UCB capable of up to 800-amps).

The apparatus 100 can include the rugged and mobile base structure 102. The mobile base structure 102 is preferably constructed from steel or another durable material and can be adapted to accommodate Level 3 DC fast chargers or similar high-power EV charging equipment such as, for example, a power supply which may be contained within or part of a convenience receptacle or electrical enclosure 136. A transformer 137 may be co-located and associated with the electrical enclosure 136. It should be appreciated that although reference is made herein to Level 3 charging, the embodiments are not limited to Level 3 charging devices but can be adapted to support other charging devices and systems such as Level 1 and Level 2 chargers.

The mobile base structure 102 can include or support a mounting plate 104, which can extend substantially across the top of the mobile base structure 102 and in some embodiments may be divided into sections. That is, the mounting plate 104 may be composed of a single integrated plate or may be divided into separate plates which sit atop the mobile base structure 102 and essentially act as a platform to support the aforementioned charging device and other components such as the electrical enclosure 136. The mobile base structure 102 including the mounting plate 104 can provide structural support and physical protection for the charging device, while also enabling safe and efficient transport and deployment in a variety of operating environments.

The mounting plate 104 can serves as the interface between the mobile base structure 102 and the charging device. In some embodiments, the mounting plate 104 may be dimensioned to accommodate EV chargers with a base footprint of Equal to or less than three feet by three feet and with electrical requirements of up to 800 amps of 480-volt three-phase power. The mounting plate 104 may be replaceable or interchangeable to allow installation of different chargers having various bolt patterns and conduit openings.

To enable convenient relocation, the mobile base structure 102 can be equipped with fork tubes, positioned on at least one side of the mobile base structure 102 or on multiple sides. These tubes can be dimensioned and spaced to receive standard forklift tines, allowing the entire apparatus to be easily picked up and repositioned either on the same site or moved to a different site altogether. An example of such a fork tube is fork tube 130 shown in FIG. 1.

Note that as utilized in the context of apparatus 100, the term “fork tube” can relate to a hollow, elongated structural feature that can be integrated into or affixed to the mobile base structure 100. Such a fork tube can be dimensioned and spaced to receive the tines of a standard forklift, thereby enabling the apparatus to be lifted, transported, and repositioned with ease. Typically fabricated from steel or another durable material, the fork tubes can be positioned on one or more sides of the mobile base structure 102 and are important for enabling safe and efficient relocation of the entire charging unit in both temporary and permanent deployment scenarios.

The apparatus 100 can also include one or more brackets such as L-shaped mounting or transport brackets, which can facilitate securing the mobile base structure 102 during transport or anchoring it in place when in use. These brackets may be permanently affixed to the mobile base structure 102 or configured for removable or adjustable positioning depending on site conditions.

To ensure stability, particularly when deployed on uneven or high-traffic surfaces, the apparatus 100 can further include one or more outriggers such as, for example, outriggers 282 and 284 (see dashed circular lines in FIG. 1 indicative of the outrigger components) extendable from the mobile base structure 102. Each of the outriggers 282 and 284 contain outrigger support components. For example, outrigger 282 includes a retractable extension 132 that engages with a support leg 117 located above a leveling mount 119. The outrigger 284 similarly includes a retractable extension 134, a support leg tube 121 and a leveling mount 123. A portion of another outrigger is also shown in FIG. 1 as support leg 127. One or more of the bollards can engage with the outriggers. For example, bollard 116 may engage with outrigger 282 and bollard 184 can engage with outrigger 284 as shown in FIG. 1.

The outriggers may be folded or telescoped into a retracted position for transport and quickly deployed to a widened configuration to increase the footprint of the apparatus 100 and reduce the risk of tipping. The outriggers may also include other engagement features such as ground spikes or pads to improve grip and load distribution.

The bollards 114, 116, 118, 120, 122, 124, 126 can be provided for impact protection. These bollards 114, 116, 118, 120, 122, 124, 126 may be positioned around the perimeter of the mobile base structure 102 to shield the charging device from vehicle strikes or other external impacts. In certain embodiments, the bollards 114, 116, 118, 120, 122, 124, 126 can be removably attachable to the tops of the deployed outriggers, thereby offering both enhanced protection and reduced tripping hazards by utilizing otherwise protruding elements for safety integration.

In addition to structural elements, the apparatus 100 includes onboard storage compartments 162, 164, and 166 integrated into the mobile base structure 102. These compartments 162, 164, and 166 may be used to store accessories such as the bollards, outriggers, mounting hardware, or other components.

To provide auxiliary power support, the mobile base structure may include one or more convenience receptacles such as breaker box 105 mounted to electrical enclosure 136 and transformer 137 mounted on or near the mounting plate. These receptacles/electrical enclosures may be configured to provide power to lighting fixtures, traffic signage, security cameras, or other low- to mid-voltage equipment typically used in parking lots or temporary charging stations. In some cases, mounting points for light poles or other utility equipment may also be included.

The apparatus 100 may also be equipped with electrical fittings such as Camlock twist-lock connectors that simplify the connection of the charging device to a power source. These connectors allow the apparatus to be powered using either a building's electrical infrastructure or a generator, enabling fast deployment and activation in the field.

The mobile charging base 102 is particularly beneficial for scenarios where permanent EV infrastructure is delayed or impractical. It allows for high-speed charging of electric vehicles at sites with evolving needs, including temporary fleet locations, employee work sites, and emergency deployment zones where grid power may be disrupted or unavailable.

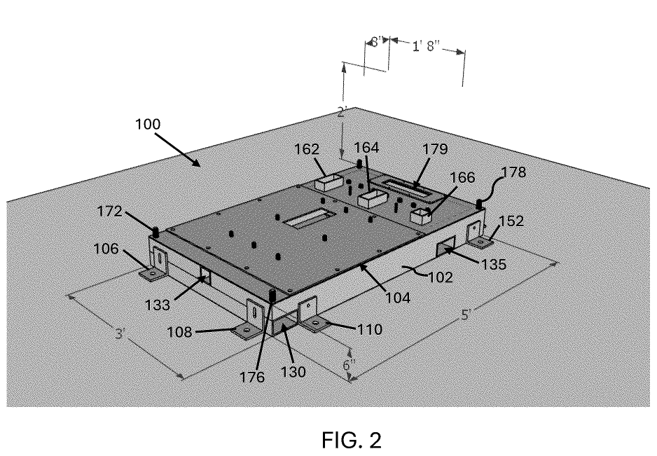

FIG. 2 illustrates a perspective of the apparatus 100 shown in FIG. 1 including the mobile base structure 102 without the bollards and other components, in accordance with an embodiments. In the view shown in FIG. 2, brackets 106, 108, 110, 152 are shown, along with channels or fork tubes 130, 133, and 135. It should be appreciated that although brackets 106, 108, 110, 152 are shown in FIG. 1, in some embodiments these components may not be needed, or perhaps only a few such brackets may be required.

Compartments 162, 164, and 166 are shown toward the backside of the apparatus 100 with respect to a gap 179 upon which convenience receptacles such as the electrical enclosure 136 and transformer 137 (not shown in FIG. 2) may be located. One or more mounting posts 172, 174, 176, 178 are also shown in FIG. 2 located at the corners of the mobile base structure 102 and atop the mounting plate 104. Note that an electrical enclosure such as breaker box 105 can be implemented as a housing/enclosure with two 120-volt receptacles, while the electrical enclosure 137 can be implemented as a 3 kVa 480-volt single phase to 120-volt transformer. This transformer can pull from two of the hot legs of a 480-volt power source and can supply up to 25-amps at 120-volt to two 15-amp breakers that each feed one duplex receptacle each (i.e., two dedicated circuits).

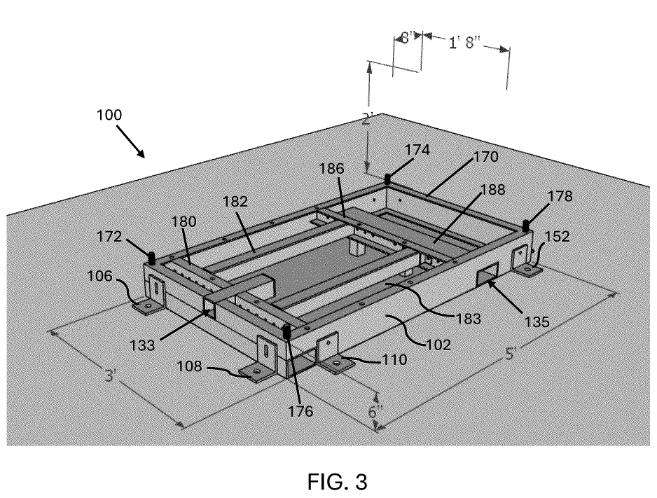

FIG. 3 illustrates an internal view of the mobile base structure 102 shown in FIG. 1 and FIG. 2, in accordance with an embodiment. The view shown in FIG. 3 includes cross braces 182 and 183 and fixed longitudinal braces 180, 186 and 188, which can be located beneath the mounting plate 104 (not shown in FIG. 3). Note that the longitudinal brace 188 can be implemented in some embodiments as, for example, a 6×3″ tube steel fork tube but also can serve as a structural component.

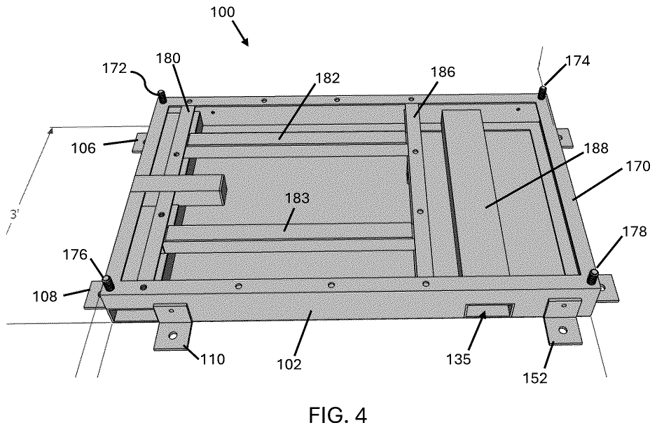

FIG. 4 illustrates a top perspective view of the apparatus 100 including the internal structural framework of the mobile base structure 102, in accordance with an embodiment. In this view, several internal components are visible, including support cross braces 182 and 183, which are adjustable. Fixed longitudinal braces 180 and 186 can be perpendicular with respect to the cross braces 182 and 183. Support cross braces 182 and 183 can extend laterally across the width of the mobile base structure 102 to provide foundational support for the mounting plate 104 (not shown in FIG. 4 for clarity). The fixed longitudinal braces 180 and 186, together with the cross braces 182 and 138 can facilitate distribution of the load of the mounted charging device and any associated power electronics or auxiliary components. Also visible in FIG. 4 is the fixed longitudinal brace 188, which can span longitudinally across the frame and can intersect or interlock with the transverse support arms to further enhance the structural rigidity of the apparatus 100. The fixed longitudinal brace 188 can also function as one of the two fork tubes.

The support arm 170 may be disposed beneath a portion of the mounting plate 104, providing additional mechanical reinforcement at specific load-bearing points. This internal framework can enable the apparatus 100 to safely carry and stabilize the weight of high-power EV charging equipment, which may include transformers, power converters, or cooling units. FIG. 4 depicts the relative positioning of the mounting posts 172, 174, 176, and 178. Each of these mounting posts may be implemented in some embodiments as, for example, 2″ mounting posts. These connectors may be preferably mounted near the corners of the mobile base structure 102 and allow for fast and secure electrical connection between the internal components of the base and an external power source, such as a building feed or generator. This configuration enhances modularity and field readiness by simplifying the hookup of the EV charging device to a power supply.

The mounting posts 172, 174, 176 and 178 in some embodiments can be implemented as, for example, 1″ mounting posts for attaching bollards 114, 116, 118, 120, 122, 124, 126 (in other embodiments these mounting posts may be 2″ mounting posts, as discussed above). Also note that in some embodiments, the mounting posts on the corners, along with outriggers and a storage area can each be implemented as a 2″ diameter pipe 3″ in height with a sealed top. Bollards can slide over pipe posts and pinned thereto.

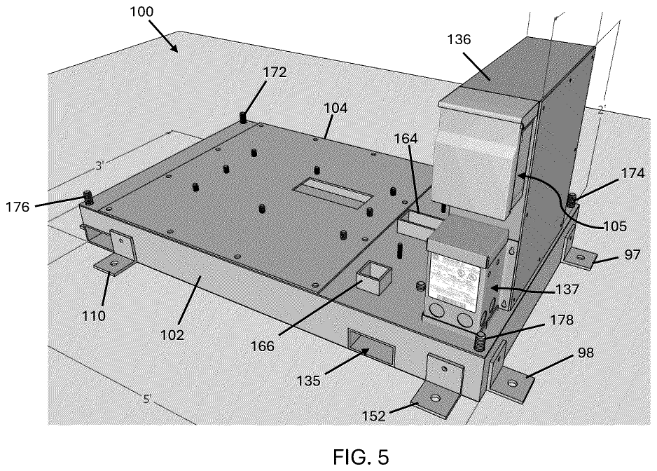

FIG. 5 illustrates a side perspective view of the apparatus 100 for supporting a charging device, in accordance with an embodiment. In this view, various external structural components are highlighted such as, for example, brackets 96, 98, 110, 152. These brackets may be used for multiple purposes, such as securing the apparatus 100, depending on deployment conditions. For example, brackets 96, 98, 110, 152 can serve as reinforced attachment points for securing the apparatus to the ground or to a stabilizing surface, especially in wind-prone or high-traffic environments. As discussed previously, such brackets may or may not be required, depending upon the situation and location and also the configuration of apparatus 100. That is, in some situations such brackets may not be needed or only a few such brackets may be required.

Also visible in FIG. 5 is a side profile of the mobile base structure 102 and a portion of the mounting plate 104 extending across the top of the apparatus 100. The orientation and design of the brackets and the side wall of the base structure may provide additional rigidity and enhance shock absorption properties when the unit is deployed on uneven or gravel surfaces commonly found in construction zones or temporary installations.

Depending on the embodiment, the brackets 96, 98, 110, 152 may be integrated or removable and may include apertures or slots for receiving bolts, pins, or other fasteners to assist in transport or installation. The side perspective shown in FIG. 5 also provides a clear view of the depth and geometric proportions of the apparatus 100, illustrating how the overall design accommodates both internal structural elements and externally mounted power components while maintaining a compact and rugged form factor.

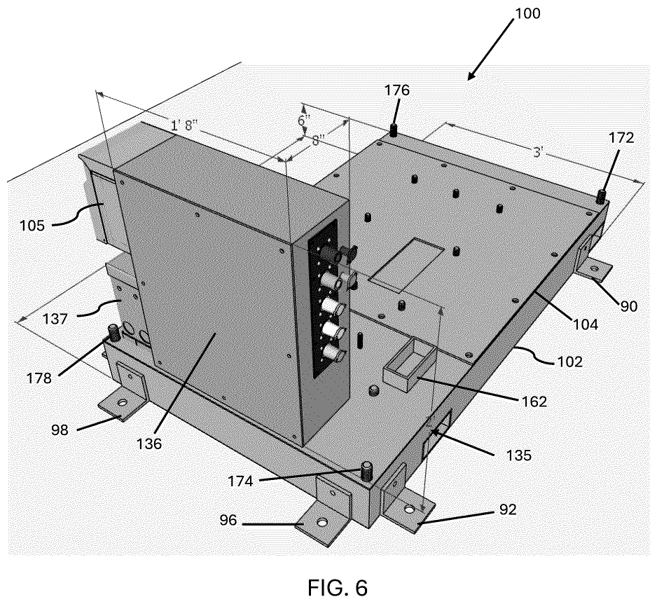

FIG. 6 illustrates a rear perspective view of the apparatus 100 for supporting a charging device, in accordance with an embodiment. This view is taken from a direction opposite that shown in FIG. 5 and provides additional detail regarding components mounted at or near the backside of the mobile base structure 102. Notably, FIG. 6 shows a rear view of convenience receptacles including electrical enclosure 136 and transformer 137, which can be mounted on or near the mounting plate 104, along with breaker box 105. These receptacles such as electrical enclosure 136 and transformer 137 may be used to power auxiliary equipment such as lighting fixtures, traffic control devices, surveillance cameras, or communications equipment, making the apparatus 100 particularly well-suited for temporary or remote site deployments.

Also visible in FIG. 6 are brackets 90 and 92, which extend from the rear side of the mobile base structure 102. These brackets may be implemented as elongated, flat bar-like support members and are positioned horizontally to facilitate mounting, stabilization, or transport-related functions. For example, brackets 90 and 92 may be used to secure cable management systems, attach protective panels, or interface with lifting or anchoring hardware during relocation of the apparatus. Their placement and shape help maintain a low profile, reducing the risk of damage or obstruction in confined or high-traffic environments.

This rear-facing perspective also offers additional insight into the geometric configuration of the base structure, highlighting the recessed or inset positioning of certain electrical and mechanical components to improve protection against environmental hazards and accidental impact.

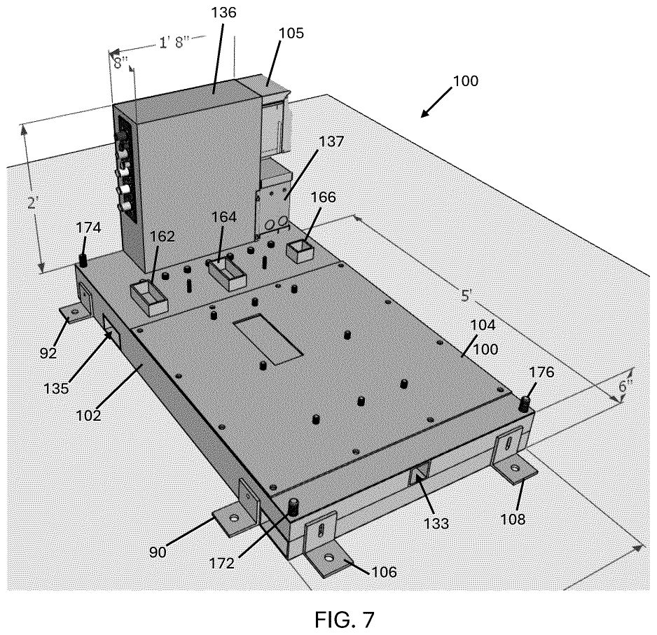

FIG. 7 illustrates a top perspective view of the apparatus 100, in accordance with an embodiment. The view shown in FIG. 7 highlights both external and partially visible structural features of the mobile base structure 102. The mounting plate 104 is prominently shown extending across the top surface of the mobile base, serving as the primary platform for mounting a high-power EV charging device. Also visible in this top-down view are fork tubes 133 and 135, which are positioned to receive forklift tines for efficient transport and redeployment of the apparatus.

Brackets can be positioned along the edges of the mobile base structure and may serve as mounting or stabilization fixtures for securing the unit in place during deployment or transport. Additionally, brackets such as brackets 90, 92 may be located toward the side corners of the mobile base. These brackets may function as support members or reinforcing components that can be located along the edge or along the sides of the base 102, offering added structural rigidity, protective framing, or attachment points for optional accessories or safety equipment. The layout presented in FIG. 7 emphasizes the modularity and rugged construction of the apparatus 100, which can be configured for field-readiness and site adaptability.

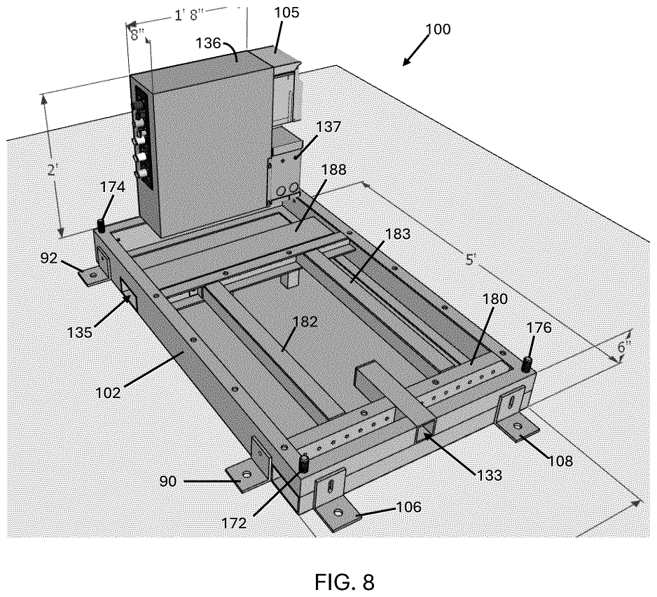

FIG. 8 illustrates a perspective and internal view of the apparatus 100, in accordance with an embodiment. In this partially exposed configuration, the figure reveals key structural components that support the mounting plate 104 and help distribute mechanical loads across the mobile base. Cross braces 182 and 183 are visible running laterally within the interior of the base structure, each configured to reinforce the load-bearing capacity of the mounting surface above. These support arms may be fabricated from steel or another high-strength material to accommodate the weight of a charger device including a Level 2 charger or a Level 3 DC fast charger or similar equipment.

The fixed longitudinal brace 188 can extend to further enhance structural stability and minimizing flexing or vibration during transport or operation. This internal perspective demonstrates how the base can be engineered for both durability and modularity, with internal cavities potentially available for routing electrical wiring, storing detachable components such as bollards or outriggers, and integrating additional mechanical fixtures as needed. The view of apparatus 100 in FIG. 8 reinforces the robust, industrial-grade construction that renders the apparatus suitable for temporary deployment in demanding environments.

As discussed previously, the apparatus 100 can support a charging device such as a Level 3 DC fast charger or similar equipment. It should be appreciated that “Level 3” charging as utilized herein generally refers to DC charging, which can involve DC current at high power, e.g., voltages above 350V and high currents leading to charging powers that are typically above 15 kW and run up to 160 kW. The disclosed embodiments are particularly well-suited for supporting Level 3 charging applications, due to several key features that address the demanding electrical, structural, and operational requirements of high-power EV charging systems. Level 3 chargers Typically range from 400 vdc to 1,000 vdc output (actual output depends on vehicle being charged infrastructure). The kW output can range up to 400 kW as seen with, for example, the ABB Terra 400 EVC. The Terra 400 can be deployed on a platform implemented by one or more embodiments, as the footprint of the Terra 400 is less than 3′×3′ and requires a 700-amp feed.

Level 3 chargers are typically large, heavy, and require robust structural support to ensure safety and stability during operation. The mobile base structure 102 of the apparatus 100 can be constructed from steel or other heavy-duty materials and includes internal support arms and braces that can bear the substantial weight and vibration of high-power components such as transformers, rectifiers, and cooling systems.

The mounting plate 104 can be specifically designed to accommodate chargers with a base footprint of less than 3′×3′ and capable of handling electrical loads up to 800 amps at 480-volt three-phase power. This meets or exceeds the requirements for most Level 3 DC fast chargers, which typically range from 50 kW to 350 kW.

Level 3 chargers are often installed in temporary, leased, or undeveloped locations where permanent infrastructure may not be available. The inclusion of fork tubes enables quick and safe relocation of the entire apparatus using standard forklifts, allowing operators to reposition or redeploy chargers as site needs change or evolve.

Due to the high voltages and currents involved in Level 3 charging, operational stability and physical protection are essential. This apparatus incorporates deployable outriggers that increase the footprint for enhanced stability, and bollards that provide critical impact protection for both the charging unit and nearby personnel or vehicles.

Level 3 chargers often require auxiliary power for site lighting, signage, or communication equipment. The apparatus includes convenience receptacles to supply power to such auxiliary systems. This makes it ideal for remote or off-grid use, where such features are essential for safety and operational readiness.

The system includes interchangeable mounting plates, enabling operators to quickly adapt the base for different charger makes or models simply by replacing the plate. In addition, camlock connectors support quick electrical hookups using either building or generator power, minimizing setup time in emergency or high-turnover environments.

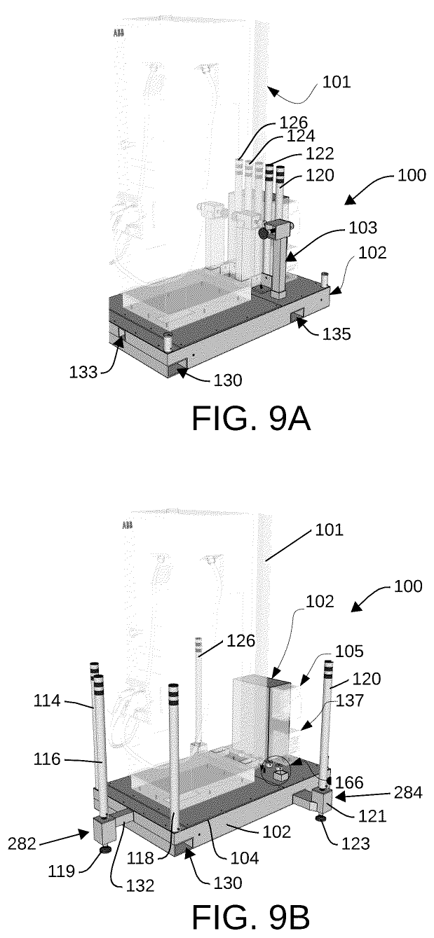

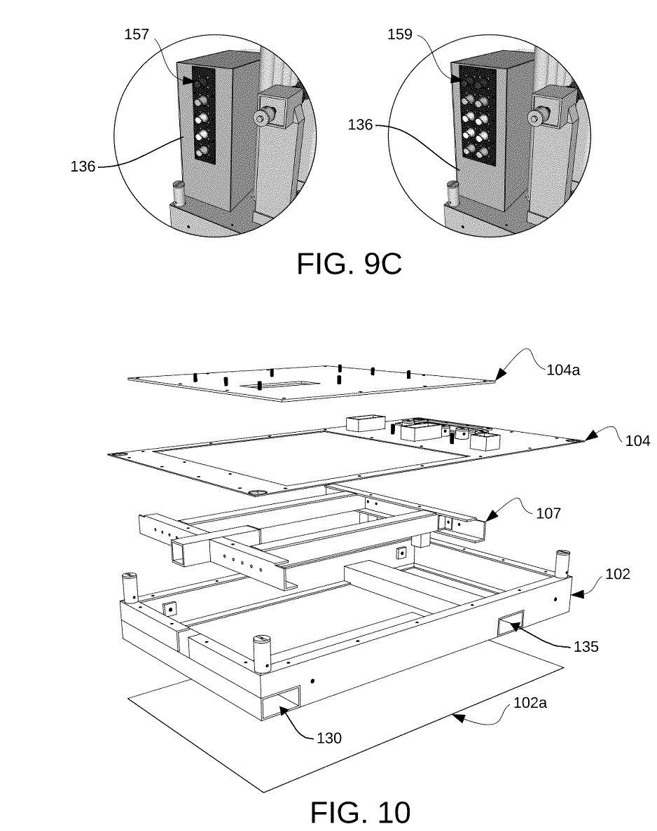

FIG. 9A and FIG. 9B illustrate varying perspective views of the apparatus 100 with bollards in different positions along with the charging device 101 supported and stabilized by the mobile base structure, in accordance with an embodiment. FIG. 9A depicts the apparatus 100 in a compact position (e.g., for transportation), and FIG. 9B demonstrates the apparatus 100 in active position (e.g., a working mode).

In the configuration shown in FIG. 9B, a breaker box 105 is shown in association with the transformer 137 and the electrical enclosure 136. The transformer 137 can be implemented in some embodiments as a 3 kVa transformer. The electrical enclosure 136 can be, for example, a UCB-400 or UCB-800, as discussed previously herein. In addition, as previously noted storage compartments such as store compartment 166 can be provided for use as storage receivers for outriggers, bollards and bracket storage, among other uses.

FIG. 9C illustrates different views of the electrical enclosure 136, in accordance with varying embodiments. The left side of FIG. 9C shows the electrical enclosure 136 in a UCB-400 embodiment with a 5-position camlock panel 157 (e.g., 400-amp). The right side of FIG. 9C depicts the electrical enclosure 136 with a 10-position camlock panel 159 (e.g., UCB-800 or 800-amp model).

FIG. 10 illustrates an exploded view of the apparatus 100, in accordance with an embodiment. Components discussed previously such as the mobile base structure 102 and the mounting plate 104 are shown in FIG. 10, along with specific parts such as a plate steel base 104a (to support the charging device 101). Note that the mobile base structure 102 can also be referred to as a channel base in some embodiments. Additionally, FIG. 10 depicts a plate sheet 102a (e.g., 18 gauge plate sheet). FIG. 10 also shows an adjustable assembly 107, which is disposed between the mobile base structure 102 and the mounting plate 104.

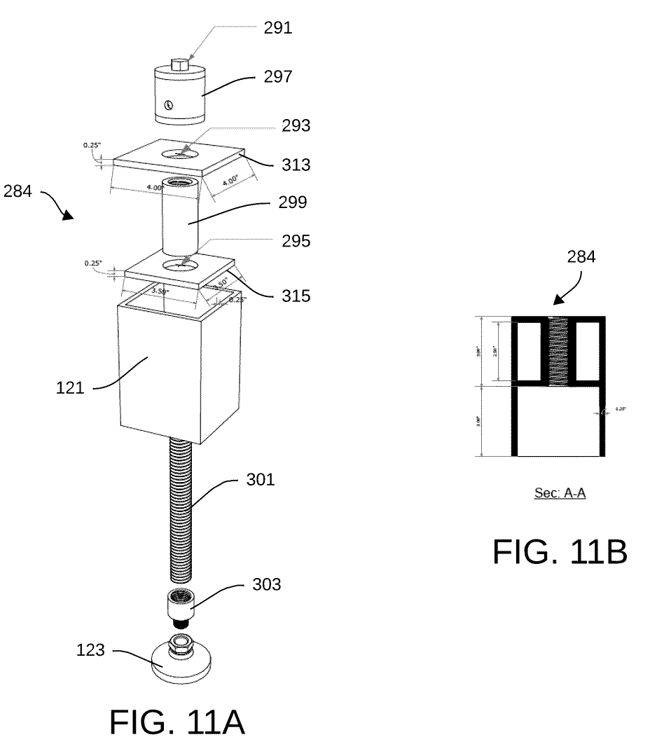

FIG. 11A and FIG. 11B illustrate an exploded view of an example outrigger leg of an outrigger such as outrigger 284, in accordance with an embodiment. The outrigger leg shown in FIGS. 11A and 11B can include a leveling mount 123 disposed beneath a spindle adapter 303 for a threaded rod 301, which are disposed within a support leg tube 121 (also can be referred to simply as a ‘support leg’). Note that the support tube 121 can be configured from steel or another durable material. A metal plate 315 can be situated within the support leg tube 121 with a hole 295 configured centrally within the metal plate 315. A tubular structure 299 (e.g., can also be configured from steel or another durable material) can be inserted into the circular hole 295 and then inserted into a metal plate 313 there above. The tubular structure 299 may be configured as a threaded coupling. A hole 293 can be configured within the metal plate 313. Finally, a DIA pipe 297 having a hex head 291 thereon may be situated at the top of the structure. FIG. 11B illustrates a sectional view of the outrigger leg of the outrigger 284.

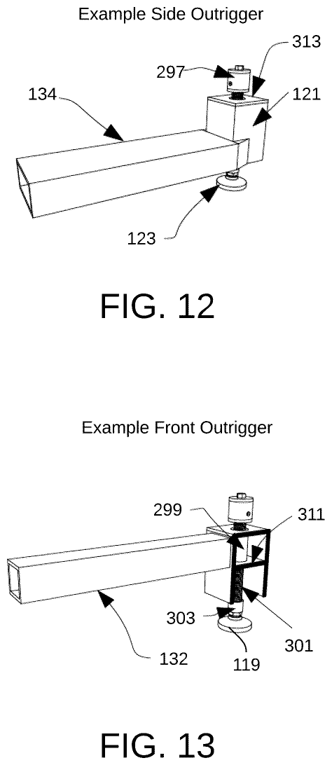

FIG. 12 illustrates a pictorial view of an example side outrigger, which can be implemented in accordance with an embodiment. The example side outrigger shown in FIG. 12 can include the previously discussed metal plate 313 and the DIA pipe 297 atop the support tube or support leg 121. The retractable extension 134 is also shown in FIG. 12. The structure depicted in FIG. 12 is supported by the leveling mount 123.

FIG. 13 illustrates a pictorial view of an example front outrigger, which can be implemented in accordance with an embodiment. The configuration depicted in FIG. 13 includes the retractable extension 132 along with other components such as the leveling mount 119, spindle adapter 303, threaded rod 301, threaded coupling 299, and metal plate 311.

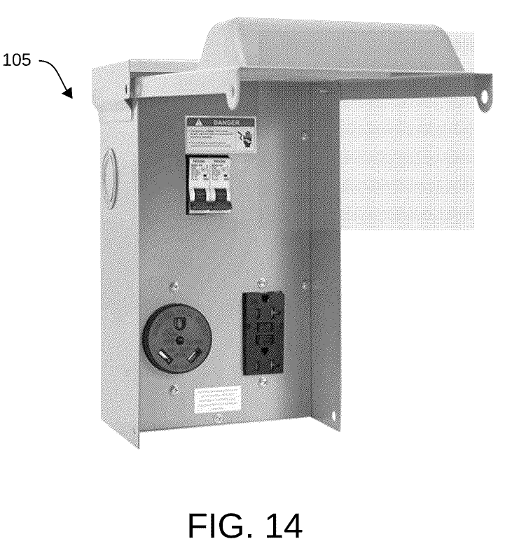

FIG. 14 illustrates a pictorial diagram of the breaker box 105, which can be implemented in accordance with an embodiment. The breaker box 105 may be implemented as a combo breaker having, for example, two duplex 120 volt receptacles.

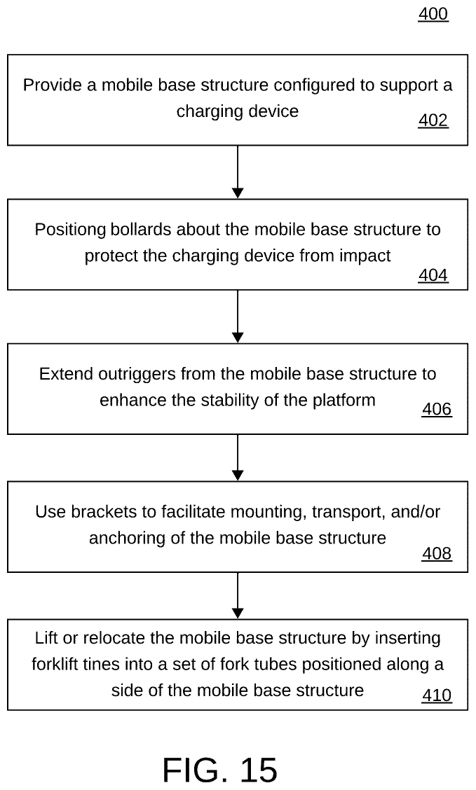

FIG. 15 illustrates a flow chart of operations depicting logical operational steps of a method 400 for deploying a charging support platform, in accordance with an embodiment. As indicated at block 402, a step or operation can be implemented for providing the mobile base structure 102 configured to support a charging device such as the charging device 101. Next, as depicted at block 404, a step or operation can be implemented to position a plurality of bollards about the mobile base structure 102 to protect the charging device from impact. Thereafter, as shown at block 406, a step or operation can be implemented for extending a plurality of outriggers from the mobile base structure to enhance the stability of the platform. Next, as depicted at block 408, a step or operation can be implemented to use a plurality of brackets to facilitate mounting, transport, or anchoring of the mobile base structure 102. Then, as shown at block 410, a step or operation can be implemented to lift or relocate the mobile base structure by inserting forklift tines into a set of fork tubes positioned along a side of the mobile base structure 102, wherein the mobile base structure 102 includes a mounting plate configured to receive the charging device.

Additional steps or operations can be implemented with the aforementioned method 400 including but not limited supporting an electric vehicle (EV) charging device with the mobile base structure, integrating a power supply with the EV charging device mounted on the mobile base structure, installing the charging device onto the mounting plate, wherein the charging device 10 can have a base footprint of less than three feet by three feet and requires up to 800 amps of 480-volt three-phase power, attaching the plurality of bollards to respective tops of the plurality of outriggers to provide impact protection while reducing tripping hazards around the deployed structure, and/or storing one or more of the bollards, outriggers, or power cables in onboard storage compartments integrated into the mobile base structure 102. An additional step or operation can involve supplying power to auxiliary equipment via at least one convenience receptacle mounted on the mobile base structure 102.

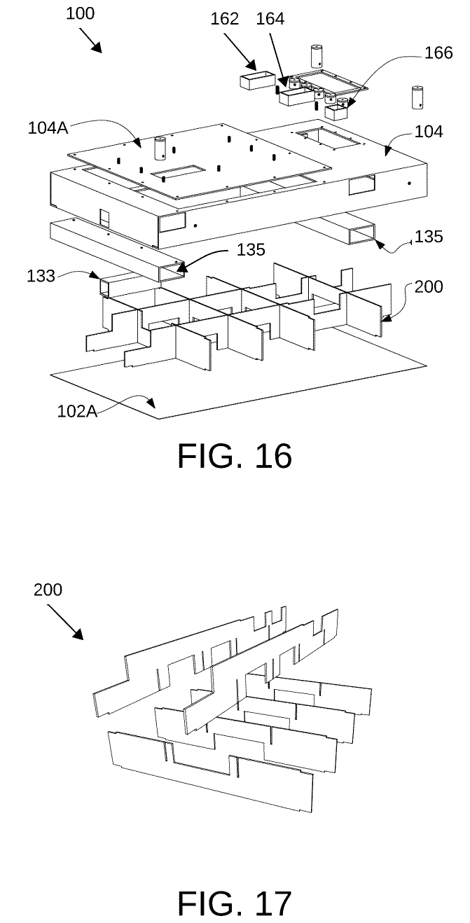

FIG. 16 illustrates an exploded and perspective view of the internal components of the apparatus 100 for supporting a charging device including the mobile base structure 102, in accordance with an embodiment. The embodiment shown in FIG. 16 and FIG. 17 represents an alternative embodiment. An interior framing 200 can be incorporated within the mobile base structure 102 in a grid like and interlocking format.

FIG. 17 illustrates a perspective view of the interior framing 200 for the mobile base structure 102, in accordance with an embodiment. The interior framing 200 can be configured in some embodiments with sheet metal portions arranged in an interlocking and grid like format.

The embodiments described herein are illustrative, and it should be understood that modifications and variations may be made without departing from the scope of the claims. For example, additional features such as locking casters, integrated cable management systems, or environmental protection elements (e.g., rain shielding, anti-corrosion coatings) may be included to further enhance the utility and durability of the apparatus.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. An apparatus for supporting a charging device, comprising:
a mobile base structure configured to support a charging device;
a plurality of bollards positioned about the mobile base structure;
a plurality of outriggers extendable from the mobile base structure to enhance stability with respect to the mobile base structure;
a plurality of brackets configured for mounting or transporting the mobile base structure; and
a set of fork tubes positioned on a side of the mobile base structure and configured to receive forklift tines for lifting and relocation of the mobile base structure;
wherein the mobile base structure includes a mounting plate configured to receive the charging device.

2. The apparatus of claim 1 wherein the charging device comprises an electric vehicle (EV) charger.

3. The apparatus of claim 2 wherein the charging device includes a power supply associated with the EV charger.

4. The apparatus of claim 1 wherein the mounting plate is configured to receive the charging device having a base footprint of less than three feet by three feet and requiring up to 800 amps of 480-volt three-phase power.

5. The apparatus of claim 1, wherein the plurality of bollards are removably attachable to respective tops of the plurality of outriggers to reduce tripping hazards and provide impact protection.

6. The apparatus of claim 1, further comprising onboard storage integrated into the mobile base structure for storing accessories including at least one of the following: the plurality of bollards, the plurality of outriggers, and a set of DLO power cables.

7. The apparatus of claim 1, further comprising at least one convenience receptacle mounted on the mobile base structure and configured to supply power to auxiliary equipment, including lighting systems.

8. A universal charging platform, comprising:
a mobile support structure configured to carry and stabilize an electric vehicle charging system;
a plurality of support brackets coupled to the mobile support structure, the support brackets configured to assist with one or more of transport, installation, or anchoring of the platform;
a set of lift-access channels formed or affixed along a lateral portion of the mobile support structure and dimensioned to receive lifting implements, including forklift tines, for repositioning or transport of the platform; and
a mounting interface provided atop the mobile support structure and configured to removably or permanently secure the electric vehicle charging system thereon.

9. The universal charging device of claim 8 further comprising a plurality of protective posts disposed around at least a portion of the mobile support structure and configured to mitigate external impact.

10. The universal charging device of claim 8 further comprising a plurality of stabilizing members extendable outwardly from the mobile support structure to increase a footprint of the platform and provide enhanced stability during operation.

11. The universal charging device of claim 8 further comprising:
a plurality of protective posts disposed around at least a portion of the mobile support structure and configured to mitigate external impact; and
a plurality of stabilizing members extendable outwardly from the mobile support structure to increase a footprint of the platform and provide enhanced stability during operation.

12. The universal charging device of claim 11, further comprising at least one convenience receptacle mounted on the mobile support structure and configured to supply power to auxiliary equipment.

13. The universal charging device of claim 12 wherein the at least one convenience receptacle comprises at least one of: an electrical enclosure and a transformer.

14. A method of deploying a charging support platform, comprising:
providing a mobile base structure configured to support a charging device;
positioning a plurality of bollards about the mobile base structure to protect the charging device from impact;
extending a plurality of outriggers from the mobile base structure to enhance the stability of the platform;
utilizing a plurality of brackets to facilitate mounting, transport, or anchoring of the mobile base structure; and
lifting or relocating the mobile base structure by inserting forklift tines into a set of fork tubes positioned along a side of the mobile base structure, wherein the mobile base structure includes a mounting plate configured to receive the charging device.

15. The method of claim 14, further comprising supporting an electric vehicle (EV) charging device with the mobile base structure.

16. The method of claim 15, further comprising integrating a power supply with the EV charging device mounted on the mobile base structure.

17. The method of claim 14, further comprising installing a charging device onto the mounting plate, wherein the charging device has a base footprint of less than three feet by three feet and requires up to 800 amps of 480-volt three-phase power.

18. The method of claim 14, further comprising attaching the plurality of bollards to respective tops of the plurality of outriggers to provide impact protection while reducing tripping hazards around the deployed structure.

19. The method of claim 14, further comprising storing one or more of the bollards, outriggers, or power cables in onboard storage compartments integrated into the mobile base structure.

20. The method of claim 14, further comprising supplying power to auxiliary equipment via at least one convenience receptacle mounted on the mobile base structure.
